(19) United States
(12) Patent Application Publication
(10) Pub. No.: US 2015/0244006 A1
(43) Pub. Date: Aug. 27, 2015

(54) FUEL CELL VEHICLE

(71) Applicant: HONDA MOTOR CO., LTD., Tokyo (JP)

(72) Inventors: Ryoichi YOSHITOMI, Utsunomiya-shi (JP); Kimiaki OHSAWA, Sakura-shi (JP)

(21) Appl. No.: 14/620,346

(22) Filed: Feb. 12, 2015

(30) Foreign Application Priority Data
Feb. 24, 2014 (JP) 2014-032432

(51) Int. Cl. H01M 8/04; B60L 11/18

(52) U.S. Cl. CPC H01M 8/04104; B60L 11/1883; B60L 11/1898; H01M 2250/20

(57) ABSTRACT

A fuel cell vehicle is equipped with a fuel cell system including a fuel cell stack, a fuel gas unit, and an oxygen-containing gas unit. In the fuel gas unit, two or more fuel gas system members are assembled together. In the oxygen-containing gas unit, two or more oxygen-containing gas system members are assembled together. Such components are assembled together in a state in which the fuel gas unit is interposed between the fuel cell stack and the oxygen-containing gas unit.

### CROSS-REFERENCE TO RELATED APPLICATION

This application is based upon and claims the benefit of priority from Japanese Patent Application No. 2014-032432 filed on Feb. 24, 2014, the contents of which are incorporated herein by reference.

### BACKGROUND OF THE INVENTION

1. Field of the Invention:

The present invention relates to a fuel cell vehicle equipped with a fuel cell system. The fuel cell system includes a fuel cell stack formed by stacking a plurality of fuel cells. Each of the fuel cells generates electricity by electrochemical reactions that take place between a fuel gas and an oxygen-containing gas.

2. Description of the Related Art:

For example, a solid polymer electrolyte fuel cell employs an electrolyte membrane. The electrolyte membrane is a polymer ion exchange membrane. In the fuel cell, the electrolyte membrane is interposed between an anode and a cathode to form a membrane electrode assembly (MEA). The membrane electrode assembly is sandwiched between a pair of separators to thereby form a power generation cell. Generally, during use of the fuel cell, a predetermined number of power generation cells are stacked together to form a fuel cell stack, for example, which is mounted in a fuel cell vehicle (fuel cell electric automobile or the like).

In particular, in the case that the fuel cell stack is mounted in a vehicle, it is desirable for fuel gas (e.g., hydrogen-containing gas) system devices and oxygen-containing gas (e.g., air) system devices to be arranged efficiently in a compact space. In this regard, when the vehicle undergoes a collision, it is required to protect the fuel gas system devices preferentially.

To this end, a fuel cell system is known, for example, as disclosed in Japanese Laid-Open Patent Publication No. 2006-221915. As shown in FIG. 7, such a fuel cell system includes a fuel cell 1 for generating electricity by consuming a hydrogen gas and an oxygen-containing gas that are supplied to the fuel cell 1. The fuel cell 1 includes two fuel cell stacks 2a, 2b, and an end plate 3 fixed to an end of the fuel cell stacks 2a, 2b.

A bracket 4 is attached to the end plate 3, and hydrogen system components 5 for supplying a hydrogen gas to the fuel cell stacks 2a, 2b are attached to the bracket 4. The hydrogen system components 5 include a hydrogen supply pipe 6a and a hydrogen discharge pipe 6b. Further, although not shown, the hydrogen system components 5 include a hydrogen inlet valve, a regulator, a hydrogen pump, a gas liquid separator, a hydrogen discharge pipe, a distribution pipe, a connection pipe, etc. At least the fuel cell stacks 2a, 2b and the hydrogen system components 5 are placed in a stack case 7.

### SUMMARY OF THE INVENTION

In Japanese Laid-Open Patent Publication No. 2006-221915, the fuel cell stacks 2a, 2b and the hydrogen system components 5 are placed in the stack case 7. Therefore, the stack case 7 has a large size, and it is not possible to achieve a reduction in the overall size of the fuel cell system. Further, since no consideration whatsoever is given to the layout of the oxygen-containing gas system components, it is difficult to improve performance during handling and assembly of the fuel cell system as a whole.

The present invention has been devised in order to solve problems of this type. An object of the present invention is to provide a fuel cell vehicle having a simple and compact structure, in which it is possible to reliably protect fuel gas system members, and to improve performance during operation of a fuel cell system as a whole.

A fuel cell vehicle according to the present invention is equipped with a fuel cell system including a fuel cell stack, a fuel gas unit, and an oxygen-containing gas unit. The fuel cell stack is formed by stacking a plurality of fuel cells in a stacking direction, and providing end plates at both ends of the fuel cells in the stacking direction. Each of the fuel cells generates electricity by electrochemical reactions that take place between a fuel gas and an oxygen-containing gas. The fuel gas unit supplies the fuel gas to the fuel cell stack, and the oxygen-containing gas supplies the oxygen-containing gas to the fuel cell stack.

In the fuel gas unit, among fuel gas system members including a fuel gas pipe and a fuel gas auxiliary device, at least two of the fuel gas system members are assembled together. In the oxygen-containing gas unit, among oxygen-containing gas system members including an oxygen-containing gas pipe and an oxygen-containing gas auxiliary device, at least two of the oxygen-containing gas system members are assembled together.

In addition, the fuel cell stack, the fuel gas unit, and the oxygen-containing gas unit are fixed together such that the fuel gas unit is at least partially interposed between the fuel cell stack and the oxygen-containing gas unit.

In the present invention, in comparison with the oxygen-containing gas system members, the fuel gas system members are disposed closer to the fuel cell stack. In such a structure, when an external load is applied to the fuel cell vehicle, it is possible to reliably protect the fuel gas system members from the external load.

Furthermore, the fuel gas unit and the oxygen-containing gas unit are assembled together beforehand, and then, the fuel cell stack, the fuel gas unit, and the oxygen-containing gas unit are fixed together. Therefore, an improvement in performance upon assembly of the fuel cell system can suitably be achieved. Further, with such a simple and compact structure, a reduction in the overall size of the fuel cell system can suitably be achieved.

In addition, the fuel cell stack, the fuel gas unit, and the oxygen-containing gas unit are fixed together, and are movable together as a whole. Accordingly, when an external load is applied to such components, it becomes possible to suppress damage to the fuel cell system to the greatest possible extent.

The above and other objects, features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a plan view schematically showing a fuel cell vehicle according to an embodiment of the present invention;

FIG. 2 is a schematic explanatory view of the fuel cell vehicle;

FIG. 3 is a partial exploded perspective view showing main components of the fuel cell vehicle;

FIG. 4 is a partial exploded perspective view showing a fuel cell stack of the fuel cell vehicle;

FIG. 5 is a front view showing main components of a fuel cell system as viewed from the front side of the vehicle;

FIG. 6 is a side view showing main components of the fuel cell system as viewed from a lateral side of the vehicle; and

FIG. 7 is a view schematically showing the fuel cell system disclosed in Japanese Laid-Open Patent Publication No. 2006-221915.

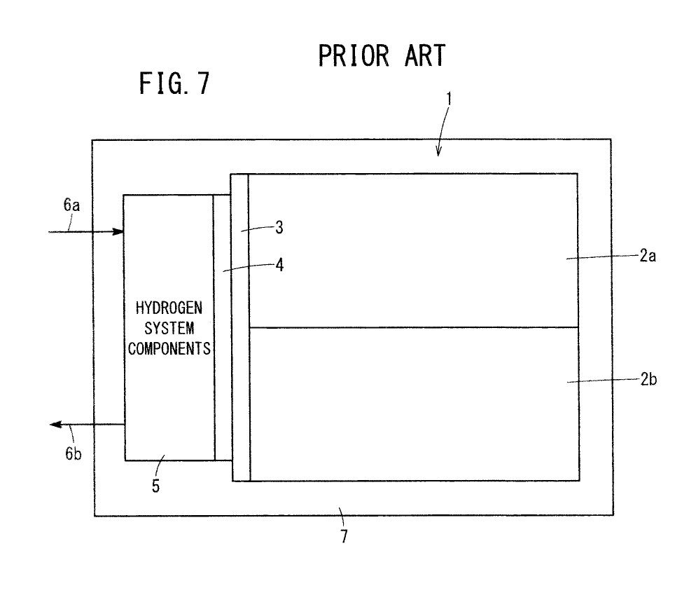

### DESCRIPTION OF THE PREFERRED EMBODIMENTS

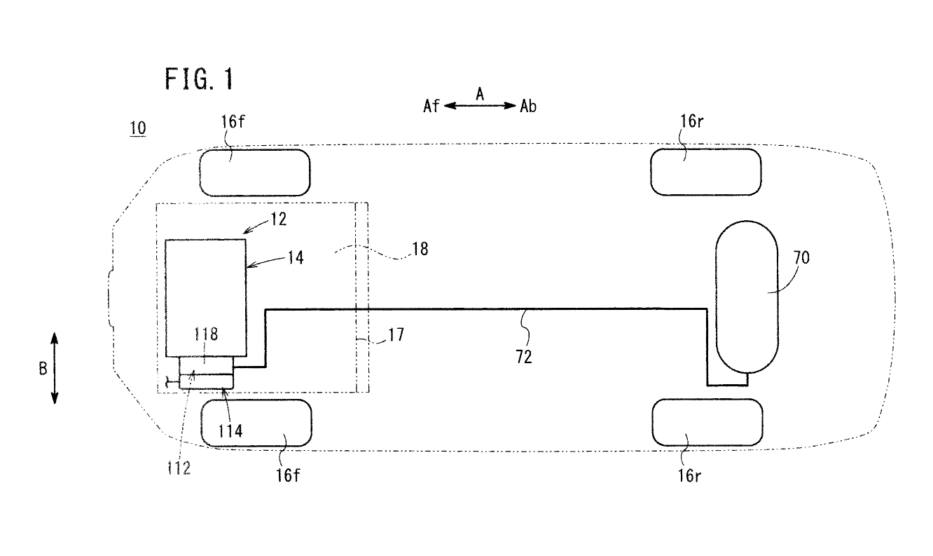

As shown in FIG. 1, a fuel cell vehicle 10 according to an embodiment of the present invention is a fuel cell electric automobile, for example. In the fuel cell vehicle 10, a fuel cell stack 14 of a fuel cell system 12 is provided in a front room (motor room) 18 of the fuel cell vehicle 10, which is positioned adjacent to front wheels 16f on a front side of a dash board 17. A hydrogen tank 70, to be described later, is provided between rear wheels 16r.

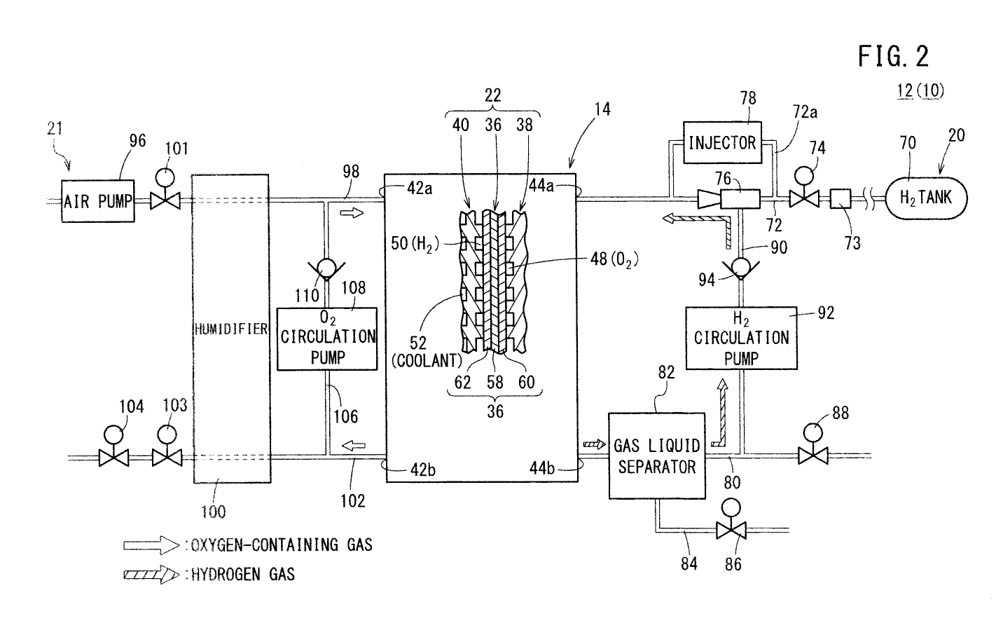

As shown in FIG. 2, the fuel cell vehicle 10 includes a fuel cell stack 14, a fuel gas supply apparatus 20 for supplying a fuel gas to the fuel cell stack 14, and an oxygen-containing gas supply apparatus 21 for supplying an oxygen-containing gas to the fuel cell stack 14. Although not illustrated, the fuel cell vehicle 10 also includes a coolant supply apparatus for supplying a coolant to the fuel cell stack 14.

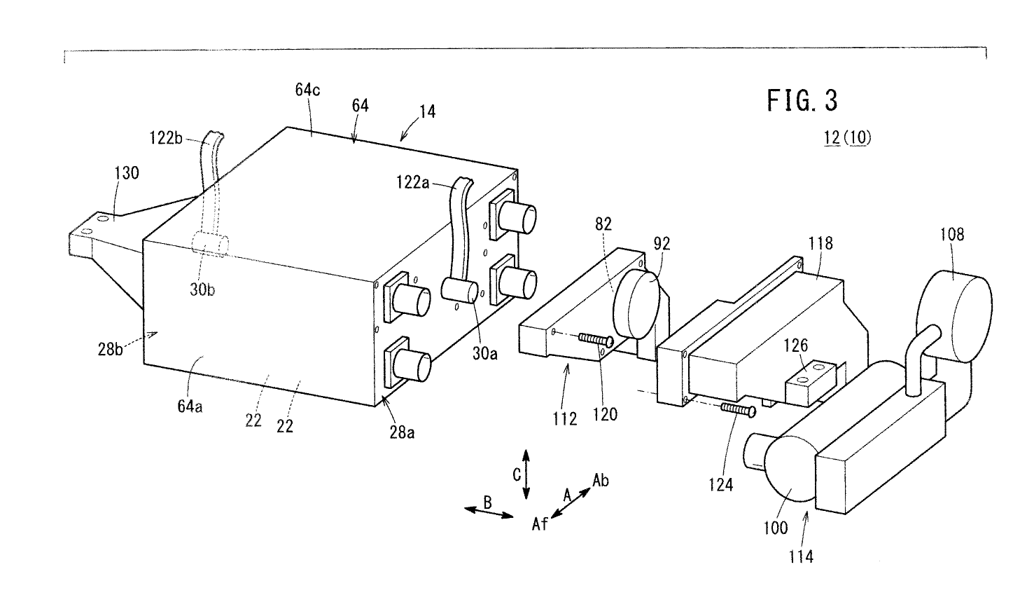

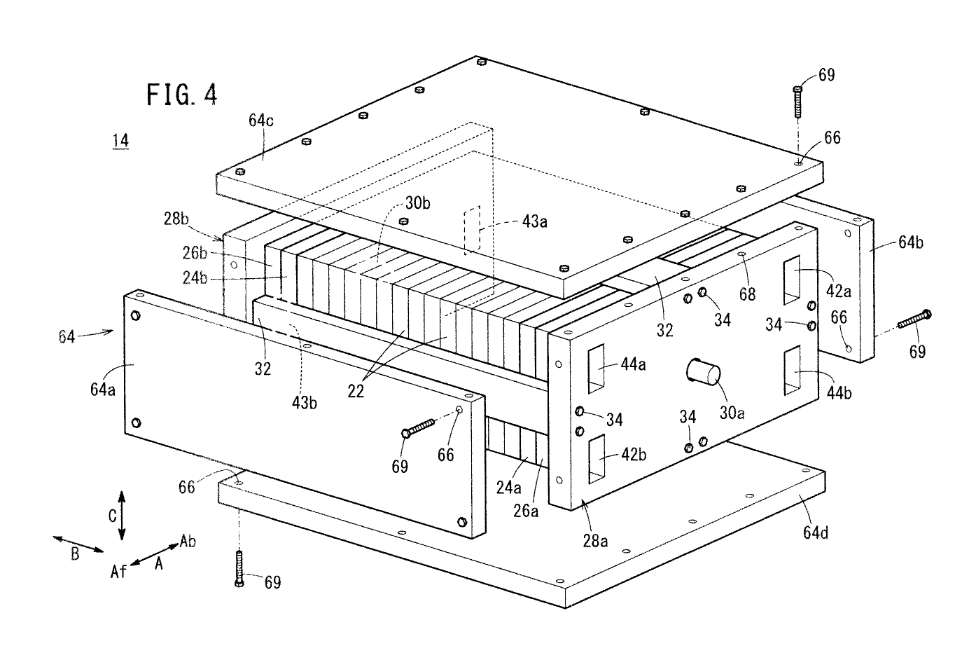

As shown in FIGS. 3 and 4, the fuel cell stack 14 is formed by stacking a plurality of fuel cells 22 in a widthwise direction of the vehicle as indicated by the arrow B. As shown in FIG. 4, a first terminal plate 24a is disposed at one end of the fuel cell 22 in the stacking direction. A first insulating plate 26a is disposed outside of the first terminal plate 24a, and a first end plate 28a (one of a pair of end plates) is provided outside of the first insulating plate 26a. A second terminal plate 24b is disposed at the other end of the fuel cell 22 in the stacking direction. A second insulating plate 26b is disposed outside of the second terminal plate 24b, and a second end plate 28b is disposed outside of the second insulating plate 26b. The first end plate 28a and the second end plate 28b are disposed at both ends of the fuel cell stack 14 in the widthwise direction of the vehicle.

Outer sizes of the first end plate 28a and the second end plate 28b are larger than outer sizes of the fuel cell 22, the first insulating plate 26a, and the second insulating plate 26b. A first power output terminal 30a extends from a central position of the first end plate 28a. The first power output terminal 30a is connected to the first terminal plate 24a. A second power output terminal 30b extends from a central position of the second end plate 28b. The second power output terminal 30b is connected to the second terminal plate 24b.

Opposite ends of coupling bars 32 are fixed to sides of the first end plate 28a and the second end plate 28b, respectively, using a plurality of screws 34. As indicated by the arrow B, a tightening load is applied to the plurality of stacked fuel cells 22 in the stacking direction.

As shown in FIG. 2, each of the fuel cells 22 is formed by sandwiching a membrane electrode assembly 36 between a first separator 38 and a second separator 40. The first separator 38 and the second separator 40 are composed of metal separators or carbon separators.

As shown in FIG. 4, at one end of the fuel cells in the direction of the arrow A, an oxygen-containing gas supply passage 42a, a coolant supply passage 43a, and a fuel gas discharge passage 44b are arranged in the vertical direction as indicated by the arrow C. The oxygen-containing gas supply passage 42a, the coolant supply passage 43a, and the fuel gas discharge passage 44b extend through the fuel cells 22 in the stacking direction as indicated by the arrow B. An oxygen-containing gas (hereinafter also referred to simply as air) is supplied through the oxygen-containing gas supply passage 42a. A coolant is supplied through the coolant supply passage 43a. A fuel gas such as a hydrogen-containing gas (hereinafter also referred to as a hydrogen gas) is discharged through the fuel gas discharge passage 44b.

At the other end of the fuel cells 22 in the direction of the arrow A, a fuel gas supply passage 44a for supplying the fuel gas, a coolant discharge passage 43b for discharging the coolant, and an oxygen-containing gas discharge passage 42b for discharging the oxygen-containing gas are arranged in the direction of the arrow C. The fuel gas supply passage 44a, the coolant discharge passage 43b, and the oxygen-containing gas discharge passage 42b extend through the fuel cells 22 in the direction of the arrow B.

As shown in FIG. 2, the first separator 38 has an oxygen-containing gas flow field 48 on a surface thereof that faces the membrane electrode assembly 36. The oxygen-containing gas flow field 48 is connected to the oxygen-containing gas supply passage 42a and the oxygen-containing gas discharge passage 42b. The second separator 40 has a fuel gas flow field 50 on a surface thereof that faces the membrane electrode assembly 36. The fuel gas flow field 50 is connected to the fuel gas supply passage 44a and the fuel gas discharge passage 44b.

A coolant flow field 52 is formed between the first separator 38 and the second separator 40 of the adjacent fuel cells 22. The coolant flow field 52 is connected to the coolant supply passage 43a and the coolant discharge passage 43b. Although not shown, seal members are formed integrally with the first separator 38 and the second separator 40, respectively. Alternatively, members that are distinct from the first separator 38 and the second separator 40 may be provided as seal members on the first separator 38 and the second separator 40, respectively.

The membrane electrode assembly 36 includes a solid polymer electrolyte membrane 58 formed by impregnating a thin membrane of perfluorosulfonic acid with water, for example. The solid polymer electrolyte membrane is interposed between a cathode 60 and an anode 62. Each of the cathode 60 and the anode 62 has a gas diffusion layer made of a material such as carbon paper, and an electrode catalyst layer made of a platinum alloy supported on porous carbon particles. The carbon particles are deposited uniformly on the surface of the gas diffusion layer. The electrode catalyst layer of the cathode 60 and the electrode catalyst layer of the anode 62 are fixed to both surfaces of the solid polymer electrolyte membrane 58, respectively.

As shown in FIG. 4, the oxygen-containing gas supply passage 42a, the oxygen-containing gas discharge passage 42b, the fuel gas supply passage 44a, and the fuel gas discharge passage 44b are formed in the first end plate 28a, which serves as one of the end plates. The coolant supply passage 43a and the coolant discharge passage 43b are formed in the second end plate 28b.

As shown in FIGS. 3 and 4, components of the fuel cell stack 14, except for the first end plate 28a and the second end plate 28b provided at both ends in the stacking direction, are covered by a fuel cell cover member 64. As shown in FIG. 4, the fuel cell cover member 64 includes a front side panel 64a, a rear side panel 64b, an upper panel 64c, and a lower panel 64d. The components of the fuel cell cover member 64 are fixed together to the first end plate 28a and the second end plate 28b using screws 69. The screws 69 pass through holes 66, and are screwed into respective screw holes 68.

As shown in FIG. 2, the fuel gas supply apparatus includes a hydrogen tank 70 for storing high pressure hydrogen. The hydrogen tank 70 is connected through a hydrogen supply channel 72 to the fuel gas supply passage 44a of the fuel cell stack 14. In the hydrogen supply channel 72, a pressure reducing valve 73, an interruption valve 74, and an ejector 76 are provided. An injector 78 is provided in a bypass flow path 72a that bypasses the ejector 76. The injector 78 is used for adjusting the flow rate, humidity, and temperature of the fuel gas.

An off gas channel 80 is connected to the fuel gas discharge passage 44b of the fuel cell stack 14. The off gas channel 80 is connected to a gas-liquid separator 82, and a drain channel 84 for discharging a liquid component is disposed in the gas-liquid separator 82. A drain valve 86 is arranged in the drain channel 84. A purge valve 88 is connected to the off gas channel 80. One end of a circulation channel 90 is connected to the off gas channel 80 at a position upstream from the purge valve 88. The other end of the circulation channel 90 is connected to an ejector 76. A fuel gas circulation pump 92 and a check valve 94 are arranged at midway positions in the circulation channel 90.

The oxygen-containing gas supply apparatus 21 includes an air compressor (air pump) 96 for compressing atmospheric air, and then supplying the compressed air. The air pump 96 is arranged in an oxygen-containing gas supply channel 98. A humidifier 100 for exchanging water content and heat between the supplied gas (supplied oxygen-containing gas) and the discharged gas (discharged oxygen-containing gas) is arranged in the oxygen-containing gas supply channel 98. A seal valve 101 is disposed between the air pump 96 and the humidifier 100. The oxygen-containing gas supply channel 98 is connected to the oxygen-containing gas supply passage 42a of the fuel cell stack 14.

The oxygen-containing gas supply apparatus 21 includes an oxygen-containing gas discharge channel 102, which is connected to the oxygen-containing gas discharge passage 42b. The oxygen-containing gas discharge channel 102 is connected to a humidification medium channel (not shown) of the humidifier 100. In the oxygen-containing gas discharge channel 102, a seal valve 103 and a back pressure valve 104 are arranged at positions downstream from the humidifier 100. The oxygen-containing gas supply channel 98 and the oxygen-containing gas discharge channel 102 are provided between the fuel cell stack 14 and the humidifier 100, and are connected by a return channel 106. An oxygen-containing gas circulation pump 108 and a check valve 110 are arranged in the return channel 106.

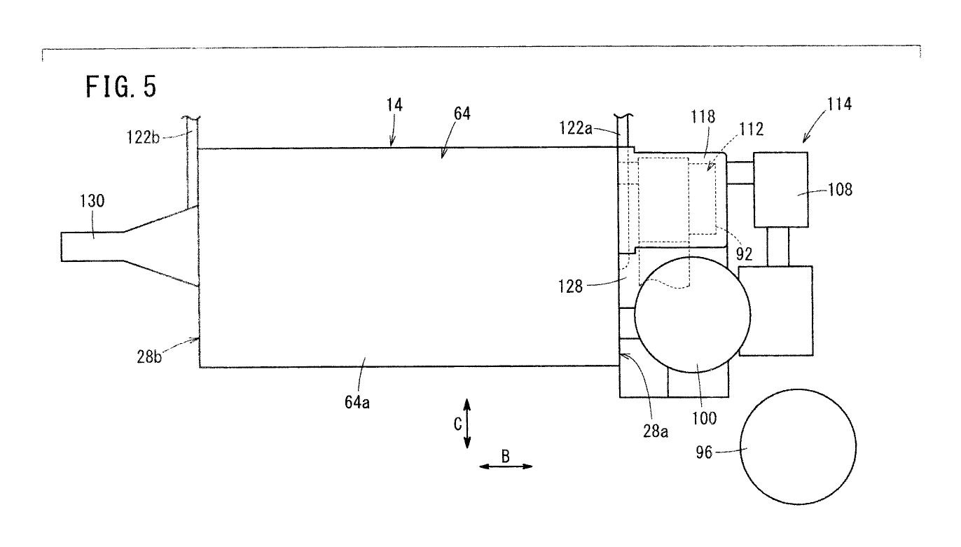

As shown in FIGS. 3 and 5, the fuel cell system includes the fuel cell stack 14, a fuel gas unit 112, and an oxygen-containing gas unit 114. As shown in FIG. 3, the fuel gas unit 112 is attached to the first end plate 28a of the fuel cell stack 14. A fuel gas unit cover member 118 is attached to the first end plate 28a in surrounding relation to the fuel gas unit 112. An oxygen-containing gas unit 114 is fixed to the fuel gas unit cover member 118.

Further, in the fuel gas unit 112, among the fuel gas system members including the fuel gas pipes and the fuel gas auxiliary devices, at least two of the fuel gas system members are assembled together. For example, the fuel gas pipes include the hydrogen supply channel 72, the off gas channel 80, and the circulation channel 90, and such components are assembled together directly, or are assembled together using a bracket. Further, for example, the fuel gas auxiliary devices include the pressure reducing valve 73, the interruption value 74, the ejector 76, the injector 78, the gas-liquid separator 82, the drain valve 86, the purge valve 88, the fuel gas circulation pump 92, and the check valve 94, and at least two of such components are assembled together directly, or are assembled together using a bracket.

In the oxygen-containing gas unit 114, among the oxygen-containing gas system members including the oxygen-containing gas pipes and the oxygen-containing gas auxiliary devices, at least two of the oxygen-containing gas system members are assembled together. For example, the oxygen-containing gas pipes include the oxygen-containing gas supply channel 98, the oxygen-containing gas discharge channel 102, and the return channel 106, and such components are assembled together directly, or are assembled together using a bracket. Further, for example, the oxygen-containing gas auxiliary devices include the air pump 96, the humidifier 100, the seal valves 101, 103, the back pressure valve 104, the oxygen-containing gas circulation pump 108, and the check valve 110, and such components, with the exception of the air pump 96, are assembled together directly, or are assembled together using a bracket.

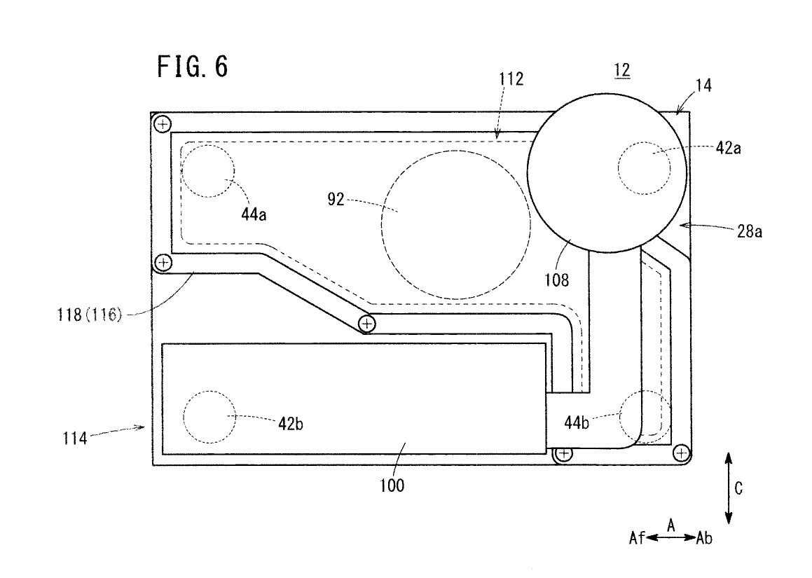

The fuel gas unit 112 is fixed to the first end plate 28a using a plurality of screws 120. As shown in FIG. 6, preferably, the fuel gas unit 112 is placed within an area formed by a frontal projection of the first end plate 28a.

As shown in FIG. 3, a first cable member 122a is connected to a first power output terminal 30a, and a second cable member 122b is connected to a second power output terminal 30b. The first cable member 122a passes between the fuel cell stack 14 and the fuel gas unit 112 in the widthwise direction of the vehicle as indicated by the arrow B (see FIG. 5).

As shown in FIG. 3, using a plurality of screws 124, the fuel gas unit cover member 118 is fixed to the first end plate 28a in order to cover the fuel gas unit 112. The outer shape of the fuel gas unit cover member 118 is formed to correspond with the shape of a portion where the oxygen-containing gas unit 114 is attached. The fuel gas unit cover member 118 further includes a mounting section 126. The mounting section 126 is fixed to a non-illustrated vehicle frame of the fuel cell vehicle 10.

As shown in FIG. 5, the humidifier 100 is disposed adjacent to a lower position of the fuel gas unit 112 that is attached to the fuel cell stack 14. More specifically, a space 128 is formed between a lower portion of the first end plate 28a of the fuel cell stack 14 and a bottom surface of the fuel gas unit 112. The humidifier 100 is arranged inside the space 128 at a position adjacent to the bottom of the fuel gas unit 112. Preferably, the humidifier 100 is disposed as closely as possible to the first end plate 28a.

The air pump 96 of the oxygen-containing gas unit 114 is separated from the other components of the oxygen-containing gas system members, and is provided at a position spaced downwardly from the fuel cell stack 14 and the fuel gas unit 112 in the vertical direction.

As shown in FIG. 6, the axis of the fuel gas circulation pump 92 and the axis of the oxygen-containing gas circulation pump 108 are offset from each other in the direction of the vehicle axis. The fuel gas circulation pump 92 is arranged within a surface of the first end plate 28a, and the oxygen-containing gas circulation pump 108 is disposed above the fuel gas circulation pump 92 in the vertical direction.

As shown in FIG. 5, a mount member 130 is attached to the second end plate 28b. The mount member 130 is fixed to a vehicle frame (not shown) of the fuel cell vehicle 10.

Operations of the fuel cell vehicle 10 will be described below.

First, as shown in FIG. 2, during operation of the fuel cell vehicle 10, the interruption valve 74 is opened in the fuel gas supply apparatus 20, whereupon hydrogen gas is discharged from the hydrogen tank 70. After the pressure of the hydrogen gas has been reduced by the pressure reducing valve 73, the hydrogen gas is supplied to the hydrogen supply channel 72. The hydrogen gas flows through the hydrogen supply channel 72, and thereafter, the hydrogen gas is supplied to the fuel gas supply passage 44a of the fuel cell stack 14.

The hydrogen gas flows from the fuel gas supply passage 44a into the fuel gas flow field 50 of the second separator 40. The hydrogen gas is supplied along the anode of the membrane electrode assembly 36 for inducing an electrochemical reaction at the anode 62.

Meanwhile, in the oxygen-containing gas supply apparatus 21, the oxygen-containing gas (air) is supplied to the oxygen-containing gas supply channel 98 through the air pump 96. The oxygen-containing gas flows through the humidifier 100, and after the oxygen-containing gas has been humidified by the humidifier 100, the oxygen-containing gas is supplied to the oxygen-containing gas supply passage 42a of the fuel cell stack 14. The oxygen-containing gas flows from the oxygen-containing gas supply passage 42a into the oxygen-containing gas flow field 48 of the first separator 38. The oxygen-containing gas is supplied along the cathode 60 of the membrane electrode assembly 36 for inducing an electrochemical reaction at the cathode 60.

Thus, in the membrane electrode assembly 36, the hydrogen gas supplied to the anode 62 and the air supplied to the cathode 60 are consumed in electrochemical reactions that take place between the catalyst layers of the anode 62 and the cathode 60 for thereby generating electricity.

The consumed hydrogen gas is discharged from the fuel gas discharge passage 44b into the off gas channel 80, and then flows into the gas-liquid separator 82. In the gas-liquid separator 82, water, which is in a liquid state, is removed from the hydrogen gas, and the remaining hydrogen gas is sucked into the ejector 76 through the circulation channel 90. The hydrogen gas is supplied again as a fuel gas to the fuel cell stack 14. Meanwhile, the consumed air is discharged as exhaust air from the oxygen-containing gas discharge passage 42b into the oxygen-containing gas discharge channel 102. The exhaust air is sent to the humidifier 100. In the humidifier 100, water content and heat move from the exhaust air and through the water permeable membrane to thereby humidify the newly supplied air. Thereafter, the exhaust air is discharged to the exterior.

Further, the coolant is supplied from the non-illustrated coolant supply apparatus into the coolant supply passage 43a. The coolant flows into the coolant flow field 52 between the first separator 38 and the second separator 40, to thereby cool the membrane electrode assembly 36. Thereafter, the coolant flows through the coolant discharge passage 43b, and the coolant is discharged into the coolant circulation system.

In the embodiment of the present invention, as shown in FIGS. 3 and 5, the fuel gas unit 112 is attached to the first end plate 28a of the fuel cell stack 14. Further, the oxygen-containing gas unit 114 is attached to the fuel gas unit 112, at a position on an opposite side from the first end plate 28a. In such a structure, in comparison with the oxygen-containing gas system members, the fuel gas system members are located more closely to the fuel cell stack 14.

Thus, when an external load is applied to the fuel cell vehicle 10, since the fuel gas system members are spaced remotely from the external load, the fuel gas system members can be protected reliably through the oxygen-containing gas system members.

Further, in the fuel gas unit 112, among the fuel gas system members including the fuel gas pipes and the fuel gas auxiliary devices, at least two of the fuel gas system members are assembled together beforehand. Likewise, in the oxygen-containing gas unit 114, among the oxygen-containing gas system members including the oxygen-containing gas pipes and the oxygen-containing gas auxiliary devices, at least two of the oxygen-containing gas system members are assembled together beforehand.

Thereafter, the fuel cell stack 14, the fuel gas unit 112, and the oxygen-containing gas unit 114 are assembled together using the fuel gas unit cover member 118. Therefore, an improvement in performance upon assembly of the fuel cell system 12 can suitably be achieved. Moreover, with the simple and compact structure, a reduction in the overall size of the fuel cell system 12 can advantageously be achieved.

Further, the fuel cell stack 14, the fuel gas unit 112, and the oxygen-containing gas unit 114 are fixed together, and can be moved together as a whole. Accordingly, when an external load is applied to such components, it is possible to suppress damage to the fuel cell system 12 to the greatest extent possible.

Further, the fuel gas supply passage 44a, the fuel gas discharge passage 44b, the oxygen-containing gas supply passage 42a, and the oxygen-containing gas discharge passage 42b are disposed in the first end plate 28a. Further, the fuel gas unit 112 and the oxygen-containing gas unit 114 are arranged on the first end plate 28a. Therefore, pipes of the fuel gas and the oxygen-containing gas are shortened to the greatest extent possible, and a reduction in the overall size of the fuel cell system 12 can easily be achieved.

Further, components of the oxygen-containing gas unit 114 are assembled together beforehand, and in such an assembled state, the oxygen-containing gas unit 114 is attached to the fuel cell stack 14. Therefore, an improvement in performance during assembly of the fuel cell system 12 can suitably be achieved.

Moreover, the oxygen-containing gas unit 114 is equipped with the humidifier 100. As shown in FIG. 5, the humidifier 100 is disposed as closely as possible to the fuel cell stack 14. With such a structure, when the fuel cell vehicle 10 is tilted, the height can easily be determined in consideration of a liquid junction, and a reduction in the overall size of the fuel cell system 12 can be achieved.

Further, in the fuel cell stack 14, components other than the first end plate 28a and the second end plate 28b are covered by the fuel cell cover member 64. Accordingly, the fuel gas unit cover member 118, which covers a portion of the fuel gas unit 112, is arranged between the fuel gas unit 112 and the oxygen-containing gas unit 114.

More specifically, the fuel cell cover member 64 and the fuel gas unit cover member 118 are provided as separate members. Therefore, an improvement in performance when maintenance operations are performed on the fuel gas unit 112 and the oxygen-containing gas unit 114 can suitably be achieved, and an improvement in performance during assembly of the fuel cell stack 14 can be achieved.

Further, the first cable member 122a for collecting electric current from the fuel cell stack 14 is provided, and the first cable member 122a passes between the fuel cell stack 14 and the fuel gas unit 112 in the widthwise direction of the vehicle (see FIGS. 3 and 5). Thus, a reduction in size of the fuel cell system 12 can be achieved, while the first cable member 122a can reliably be protected.

Moreover, as shown in FIG. 5, the oxygen-containing gas unit 114 is equipped with the air pump 96. The air pump 96 is disposed at a position spaced downwardly in the vertical direction from the fuel cell stack 14 and the fuel gas unit 112. In such a structure, the air pump 96, which does not collapse easily when a collision occurs, can be disposed at a position where the air pump 96 does not obstruct the fuel cell stack 14 and the fuel gas unit 112. Therefore, the fuel cell stack 14 and the fuel gas unit 112 can suitably be protected when an external load is applied to the fuel cell vehicle 10. Further, it is possible to suppress the influence of vibrations of the air pump 96 on the fuel cell stack 14.

Further, as shown in FIG. 6, the axis of the fuel gas circulation pump 92 of the fuel gas unit 112, and the axis of the oxygen-containing gas circulation pump 108 of the oxygen-containing gas unit 114 are offset from each other in the widthwise direction of the vehicle. Therefore, the fuel gas circulation pump 92 and the oxygen-containing gas circulation pump 108, which have large widths, do not overlap with each other, and thus, damage to the fuel cell stack 14 by the respective axes can be prevented.

While the invention has been particularly shown and described with reference to the preferred embodiment, it will be understood that variations and modifications can be adopted by those skilled in the art without departing from the scope of the invention as defined by the appended claims.

What is claimed is:

1. A fuel cell vehicle equipped with a fuel cell system, the fuel cell system comprising:
a fuel cell stack formed by stacking a plurality of fuel cells in a stacking direction and providing end plates at both ends of the fuel cells in the stacking direction, the fuel cells each generating electricity by electrochemical reactions that take place between a fuel gas and an oxygen-containing gas;
a fuel gas unit configured to supply the fuel gas to the fuel cell stack; and
an oxygen-containing gas unit configured to supply the oxygen-containing gas to the fuel cell stack, wherein:
in the fuel gas unit, among fuel gas system members including a fuel gas pipe and a fuel gas auxiliary device, at least two of the fuel gas system members are assembled together;
in the oxygen-containing gas unit, among oxygen-containing gas system members including an oxygen-containing gas pipe and an oxygen-containing gas auxiliary device, at least two of the oxygen-containing gas system members are assembled together; and
the fuel cell stack, the fuel gas unit, and the oxygen-containing gas unit are fixed together such that the fuel gas unit is at least partially interposed between the fuel cell stack and the oxygen-containing gas unit.

2. The fuel cell vehicle according to claim 1, wherein:
a fuel gas supply passage, a fuel gas discharge passage, an oxygen-containing gas supply passage, and an oxygen-containing gas discharge passage extend from one of the end plates through the fuel cell stack in the stacking direction of the fuel cells; and
the fuel gas unit and the oxygen-containing gas unit are provided at the one of the end plates.

3. The fuel cell vehicle according to claim 1, wherein, in a state in which components of the oxygen-containing gas unit are assembled together, the oxygen-containing gas unit is attached to the fuel cell stack.

4. The fuel cell vehicle according to claim 1, wherein:
the oxygen-containing gas unit comprises a humidifier as the oxygen-containing gas system member configured to humidify the oxygen-containing gas; and
the humidifier is provided adjacent to a lower position of the fuel gas unit that is attached to the fuel cell stack.

5. The fuel cell vehicle according to claim 1, wherein:
the fuel cell stack has a fuel cell cover member configured to cover the fuel cell stack, excluding both ends of the fuel cell stack where the end plates are provided;
a fuel gas unit cover member covering a portion of the fuel gas unit is provided between the fuel gas unit and the oxygen-containing gas unit; and
the fuel cell cover member and the fuel gas unit cover member are provided as separate members.

6. The fuel cell vehicle according to claim 1, wherein:
the stacking direction of the fuel cells of the fuel cell stack matches a widthwise direction of the fuel cell vehicle;
the fuel cell vehicle further comprises a cable member configured to collect electrical current from the fuel cell stack; and
the cable member passes between the fuel cell stack and the fuel gas unit in the widthwise direction of the vehicle.

7. The fuel cell vehicle according to claim 1, wherein:
the oxygen-containing gas unit has an air pump as the oxygen-containing gas system member; and
the air pump is positioned below the fuel cell stack and the fuel gas unit in a vertical direction.

8. The fuel cell vehicle according to claim 1, wherein:
the fuel gas unit has a fuel gas circulation pump as the fuel gas system member;
the oxygen-containing gas unit has an oxygen-containing gas circulation pump as the oxygen-containing gas system member; and
an axis of the fuel gas circulation pump and an axis of the oxygen-containing gas circulation pump are offset from each other in the widthwise direction of the vehicle.
